(19) United States
(12) Patent Application Publication
(10) Pub. No.: US 2007/0011379 A1
(43) Pub. Date: Jan. 11, 2007

(54) I/O energy reduction using previous bus state and I/O inversion bit for bus inversion

(76) Inventor: J. Thomas Pawlowski, Boise, ID (US)

Correspondence Address: DICKSTEIN SHAPIRO LLP, 1825 EYE STREET NW, Washington, DC, 20006-5403, US

(21) Appl. No.: 11/473,305

(22) Filed: Jun. 23, 2006

Related U.S. Application Data
(63) Continuation of application No. 10/730,896, filed on Dec. 10, 2003.

(51) Int. Cl. G06F 13/00

(52) U.S. Cl. 710/110

(57) ABSTRACT

A bus inversion method and system for capturing a previous state of a bus and its corresponding inversion bit prior to transmitting new information over the bus. The new information, state of the bus and associated inversion bit are used to determine whether the new information should be inverted before being transmitted.

### FIELD OF THE INVENTION

The invention relates generally to communications over a bus and, more particularly to, reducing energy consumed in a bussed system by using dynamic bus inversion.

### BACKGROUND

Most processing systems (e.g., computer or processor system) use high-speed, high bandwidth communication buses to transfer data, address and command information between components of the system. The components may include processors, memory subsystems and input/output devices.

A data bus, for example, is used to transmit data between two or more components and possibly to external devices. Data is typically transmitted as bytes or words (formed of multiple bytes) as opposed to individual bits. As such, the typical bus includes respective bus lines for each bit in the byte/word to be transferred. Each bus line has two possible states, one representing a first binary or logical value (e.g., “0”) and the other state representing a second binary/logical value (e.g., “1”).

Electronic switching noise occurs when a bus line switches from a first state to a second state (i.e., noise occurs when the bit on the bus transitions from a 1 to a 0 or a 0 to a 1). The amount of switching noise increases in an approximately linear fashion from an essentially non-zero noise condition (when no bits switch states). to a worst case switching noise condition (when all of the bits in a multi-bit word switch states at the same time). It is desirable to reduce the amount of switching noise on a bus that results from the transitioning of logical states of the data bits transmitted on the bus.

FIG. 1 is a block diagram illustrating a typical bussed system 10. The system includes a bus master 20 (e.g., a processor, microprocessor, application specific integrated circuit (ASIC)) and a bus slave 30 (e.g., memory circuit). The bus master 20 controls and communicates with the slave 30 over a control bus 40, address bus 50, data bus 60 and with clock signal lines 70. The system 10 may experience noise on any of the busses 40, 50, 60, 70.

Moreover, in some systems, driving a particular binary or logical value on a bit line will consume more power than when the other binary/logical value is driven on the bit line. For example, in some systems, driving a logical 0 on the bus line consumes more power than driving a 1 on the same bus line. Similarly, there are some systems in which driving a logical 1 on the bus line consumes more power than driving a 0 on the same bus line. It is desirable to reduce the energy consumed in a bussed system.

Bus inversion has been used to reduce noise and power consumption in a bussed system. Bus inversion compares existing bits on the bus (i.e., bits already transmitted, often referred to as “previous bits”) to bits to-be-transmitted (often referred to as the “preview bits” or “future bits”) to determine how many bit transitions from the previous bits will occur when the preview bits are transmitted. Bus inversion will invert all of the preview bits before transmitting them, if it is determined that inverting the bits would improve system performance (e.g., lower power consumption, produce less switching noise). Typically, an additional bit is used to indicate to a receiving device if the bits in the data word have been inverted or not. This bit is often referred to as the “inversion bit”. The receiving device inspects the inversion bit and determines if the bits have been inverted. If the received bits were inverted, the receiving device must invert the received bits before using or storing them.

Bus inversion techniques are not without their shortcomings. For example, current inversion techniques do not take into account the possible transitioning of the inversion bit when deciding whether or not to invert the preview bits. The switching of the state of the inversion bit will also cause switching noise or increase energy consumption, which is undesirable. As such, it is desirable to include the state of the inversion bit in the bus inversion decision making process to more fully minimize noise and maximize energy expenditure.

Another shortcoming of existing bus inversion methods is that they only compare the preview bits to the last bits transmitted by the component about to drive the bus (referred to herein as the “preview driver”). In a system with more than one component capable of driving the bus, it is often the case that the preview driver was not the last driver of the bus. As such, any inversion decision performed by looking at the last transmission of the preview driver would be erroneous since it is not based on the current bit states of the bus. As such, it is desirable to include the current state of the bus in the bus inversion decision making process.

### SUMMARY

The present invention provides a bus inversion technique that includes the state of the inversion bit in the bus inversion decision making process.

The present invention also provides a bus inversion technique that includes the current state of the bus in the bus inversion decision making process.

The above and other features and advantages are achieved in various embodiments of the invention by providing a bus inversion method and system that captures a previous state of a bus and its corresponding inversion bit prior to transmitting new information over the bus. The new information, state of the bus and associated inversion bit are used to determine whether the new information should be inverted before being transmitted.

### BRIEF DESCRIPTION OF THE DRAWINGS

The foregoing and other advantages and features of the invention will become more apparent from the detailed description of exemplary embodiments provided below with reference to the accompanying drawings, in which:

FIG. 1 is a block diagram illustrating a typical bussed system;

FIG. 2 is a block diagram illustrating a bussed system constructed in accordance with an exemplary embodiment of the invention;

FIG. 3 is a block diagram illustrating another bussed system constructed in accordance with another exemplary embodiment of the invention;

FIG. 4 is a flowchart illustrating a bus inversion method performed in accordance with an exemplary embodiment of the invention;

FIG. 5 is a flowchart illustrating a bus inversion method performed in accordance with an exemplary embodiment of the invention;

FIG. 6 is a diagram illustrating output driver circuitry constructed in accordance with an embodiment of the invention; and

FIG. 7 is a block diagram of a processor system utilizing bus inversion in accordance with any of the embodiments of the invention.

### DETAILED DESCRIPTION

In the following detailed description, reference is made to the accompanying drawings, which are a part of the specification, and in which is shown by way of illustration various embodiments whereby the invention may be practiced. These embodiments are described in sufficient detail to enable those skilled in the art to make and use the invention. It is to be understood that other embodiments may be utilized, and that structural, logical, and electrical changes, as well as changes in the materials used, may be made without departing from the spirit and scope of the present invention.

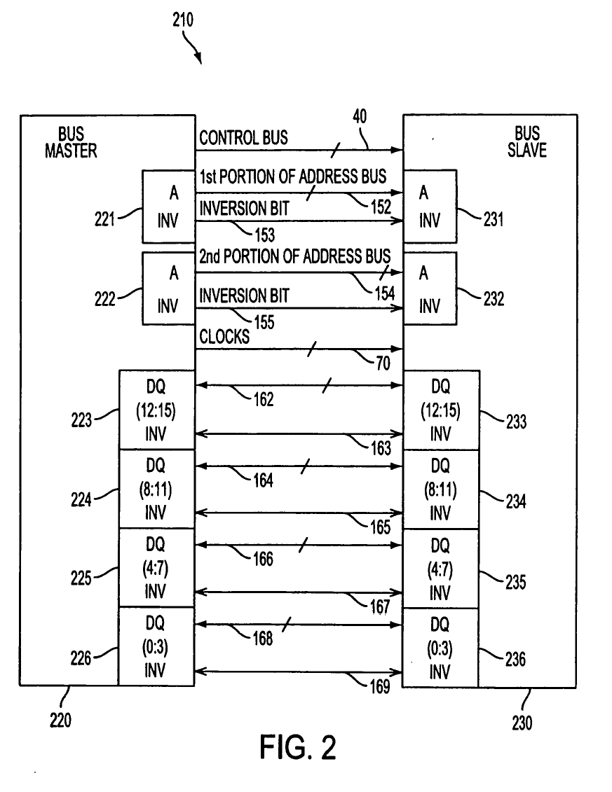

Now referring to the figures, where like reference numbers designate like elements, FIG. 2 is a block diagram illustrating a bussed system 210 constructed in accordance with an exemplary embodiment of the invention. The system 210 includes a bus master 220 and a bus slave 230. The bus master 220 may be a processor, microprocessor, or application specific integrated circuit (ASIC) designed to control other components. The bus slave 230 may be a memory circuit such as e.g., a random access memory (RAM), static RAM (SRAM), dynamic RAM (DRAM), synchronous DRAM (SDRAM), flash memory or other memory device. The bus slave may be any other device that communicates over a bus to another electrical component. It should be appreciated that the invention is not limited to any specific type of bus master 220 or slave 230.

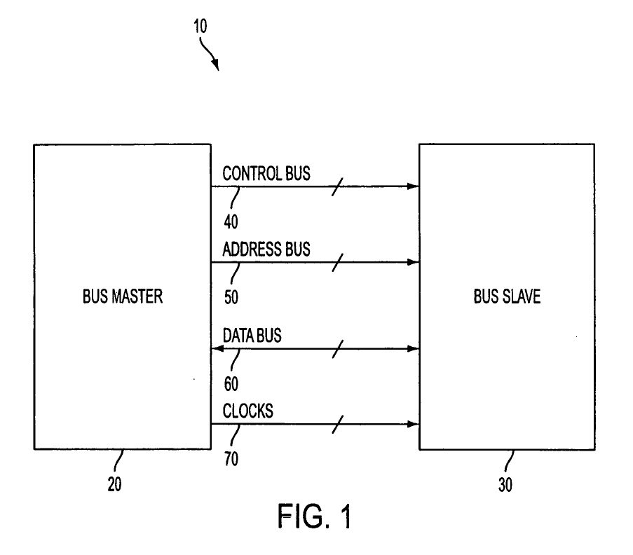

In the illustrated embodiment, the conventional address bus 50 (FIG. 1) is divided into two address buses 152, 154, with each bus 152, 154 having an associated inversion bit line 153, 155. It is desirable that the two address buses 152, 154 each comprise one half of the required address bus. Thus, each address bus 152, 154 contains enough address bus lines to accommodate one half of an address required by the system 210. In the illustrated example, each address bus 152, 154 contains eight lines corresponding to eight bits of an address.

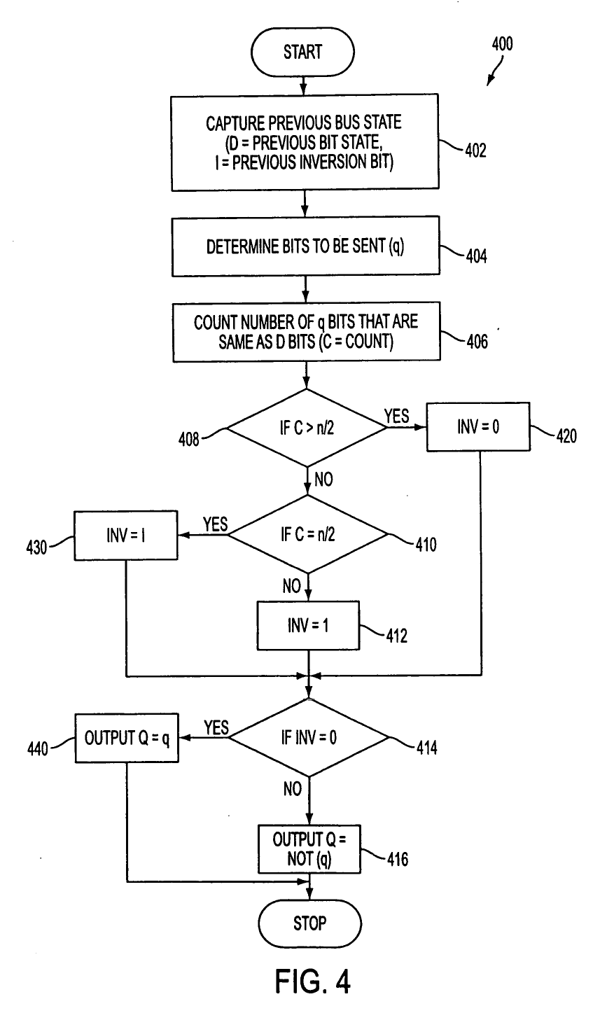

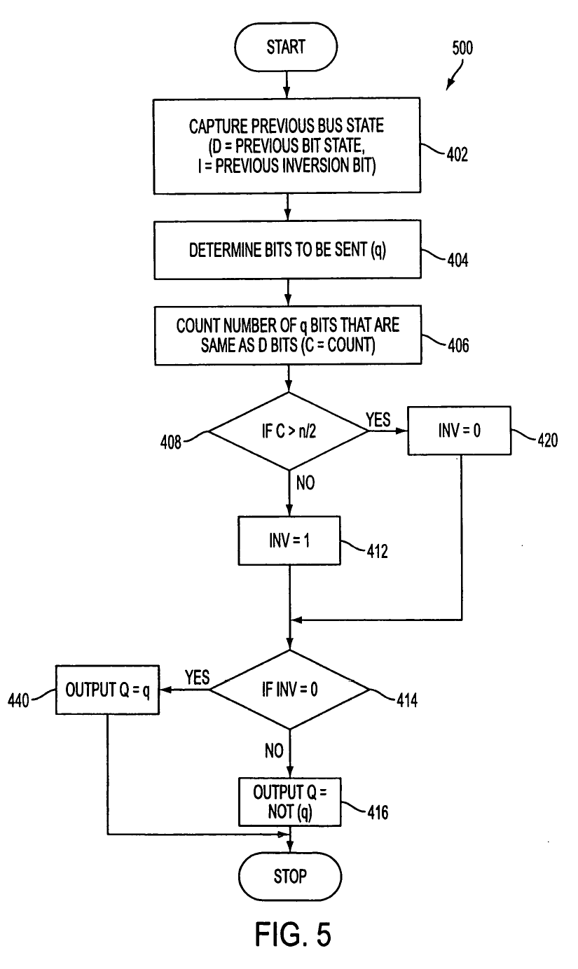

Although the inventor has determined that eight bits (i.e., one byte) for each address bus 152, 154 is desirable, the invention is not to be limited to 8-bit address buses 152, 154. For example, the invention could use one 16-bit address bus with one inversion bit; the invention could use four 4-bit address buses with 4 associated inversion bits. All that is required is that the address buses 152, 154 have associated inversion bits and that the components connected to the busses 152, 154 perform inversion processing as described below with respect to FIGS. 4-5.

In the illustrated embodiment, the conventional data bus 60 (FIG. 1) is replaced by four smaller data buses 162, 164, 166, 168, with each bus 162, 164, 166, 168 having an associated inversion bit line 163, 165, 167, 169. It is desirable that the four data buses 162, 164, 166, 168 each comprise one fourth of the required data bus. Thus, each data bus 162, 164, 166, 168 contains enough data bit lines to accommodate one fourth of the data lines required by the system 210. In the illustrated example, each data bus 162, 164, 166, 168 contains four lines corresponding to four bits of data. That is, bus 162 contains lines for carrying data bits DQ[12:15], bus 164 contains lines for carrying data bits DQ[8:11], bus 164 contains lines for carrying data bits DQ[4:7] and bus 168 contains lines for carrying data bits DQ[0:3].

Although the inventor has determined that four bits for each data bus 162, 164, 166, 168 is desirable, the invention is not to be limited to 4-bit data buses 162, 164, 166, 168. For example, the invention could use one 16-bit data bus with one inversion bit; the invention could use two 8-bit data buses with two associated inversion bits. All that is required is that the data buses 162, 164, 166, 168 have associated inversion bits and that the components connected to the buses 162, 164, 166, 168 perform inversion processing as described below with respect to FIGS. 4-5.

To accommodate the buses in the system, the bus master 220 contains address drivers 221, 222 to drive the address buses 152, 154 and inversion bit lines 153, 155 and data drivers/receivers 223, 224, 225, 226 for driving and/or receiving data over the data buses 162, 164, 166, 168 and inversion bit lines 163, 165, 167, 169. The bus slave 230 contains address receivers 231, 232 for receiving address and inversion bits over the address buses 152, 154 and inversion bit lines 153, 155 and data drivers/receivers 233, 234, 235, 236 for driving and/or receiving data over the data buses 162, 164, 166, 168 and inversion bit lines 163, 165, 167, 169. The bus master 220 also controls and communicates with the slave 230 over a control bus 40 and clock signal lines 70.

It should be noted that the control bus 40 could also be subject to bus inversion according to the invention if so desired. A typical control bus 40 includes signals such as R/W# (read if 1, write if 0), CE# (chip enabled if 0), REF# (DRAM refresh if 0) and DM (data write mask if 1). The number of transitions between states of the bits of the control bus 70 could be reduced using bus inversion (described below).

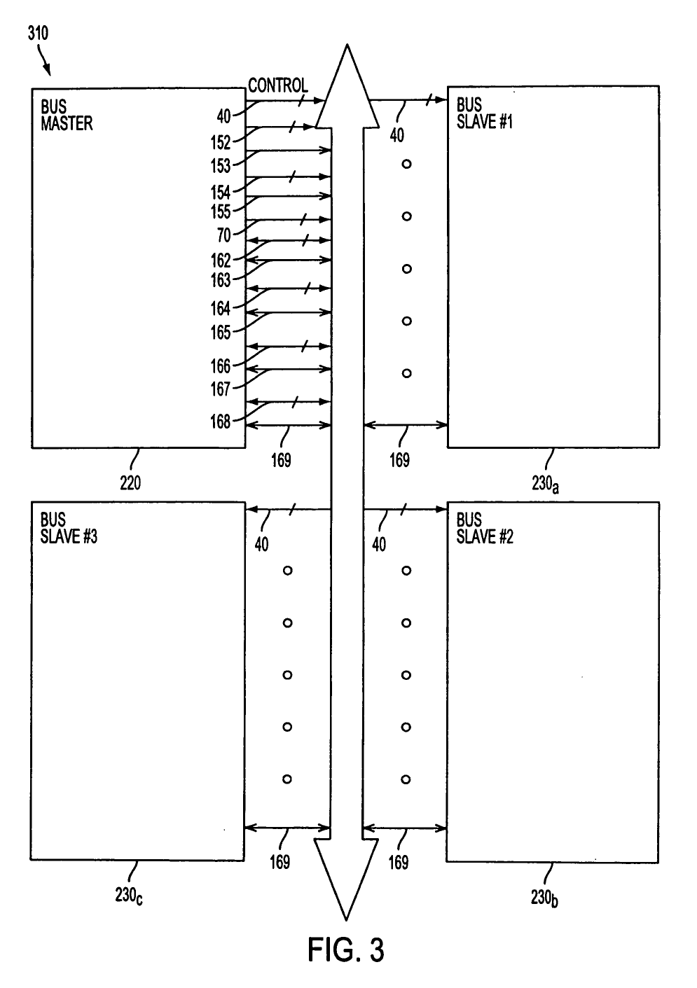

FIG. 3 is a block diagram illustrating another bussed system 310 constructed in accordance with another exemplary embodiment of the invention. In the illustrated embodiment, one bus master 220 communicates with several bus slaves 230a, 230b, 230c. It is evident from this embodiment that multiple devices are capable of driving data on to the data buses 162, 164, 166, 168. As noted above, in a system 310 with more than one device capable of driving a bus, it is often the case that the preview driver (i.e., the driver about to transfer data) was not the last driver of the bus. As such, as described below with respect to FIGS. 4 and 5, the present invention ensures that any inversion decision performed by the preview driver is based on the current bit states of the bus.

FIG. 4 is a flowchart illustrating a bus inversion method 400 performed in accordance with an exemplary embodiment of the invention. In the illustrated method 400, it is presumed that the bus contains an even number of bits n and an inversion bit INV. The output on the bus includes Q bits. The inversion bit INV is output on an inversion line associated with the bus.

The method 400 begins by capturing the previous (i.e., current) bus state (step 402). That is, the previously transmitted bits D and the previously transmitted inversion bit I are captured in this step. Next, the state (i.e.,1's and 0's) of the bits to be transmitted q (i.e., preview bits) are determined and compared to the previously transmitted bits D (step 404). It should be appreciated that steps 402 and 404 could be reversed if so desired. A count C of the number of preview bits q that are the same as the previously transmitted bits D is obtained (step 406).

At step 408 it is determined if the count C is greater than n/2 (where n is the number of bits on the bus). That is, it is determined if the number of preview bits that match the previously transmitted bits is greater than half the number of bits on the bus. If the count is greater than n/2, then the inversion bit INV is set to zero (step 420), which indicates that the bits q should not be inverted (described below) and the method 400 continues at step 414.

If at step 408 it is determined that the count is not greater than n/2, the method 400 continues at step 410 where it is determined if the count C is equal to n/2. If at step 410 it is determined that the count C is equal to n/2, the inversion bit INV is set to the captured state I of the inversion bit (step 430). That is, because the number of matching bits is the same as n/2, the number of transitions will be the same whether the preview bits q are inverted or not. Since the transition of the inversion bit INV will also affect the performance of the bus, step 430 sets the inversion bit NV to the last state of the inversion bit I so that there will not be a transition of the inversion bit INV. This is something prior bus inversion schemes do not do. As such, the method 400 reduces energy used during the transmission of the bits q and inversion bit INV while also reducing switching noise.

If at step 410 it is determined that the count C is not equal to n/2, the inversion bit INV is set to one (step 412), which indicates that the bits q should be inverted (described below). The method 400 continues at step 414, where it is determined whether the preview bits q should be inverted before being output onto the bus. If at step 414 it is determined that the inversion bit INV is set to zero, the method 400 outputs the preview bits q without inverting them as the bus output Q (step 440). If at step 414 it is determined that the inversion bit INV is not set to zero, the method 400 outputs inverted preview bits q as the bus output Q (step 416). Although not shown, the inversion bit INV is output on a corresponding inversion bit line.

It should be noted that if the method 400 is being performed in a system (e.g., system 210) comprising only two components, e.g., a CPU and a memory device, all bus transactions are directed from one device to the other. This means that the bus state is always captured by the device that receives the bus transaction. There is no wasted energy in capturing the state of the bus on these devices.

In the case where the system includes more than two components (e.g., system 310), however, one or more components would not normally need to receive every bus transaction. Thus, requiring the device(s) to capture every transaction means that the device(s) would need to perform the extra operation of capturing bus data even when it was not intended for them. This action requires the use of energy and should be avoided unless needed. In a desired embodiment, such a device operates synchronously on the data bus, and hence, has knowledge as to when the device must output data. Therefore, such a device would only need to perform this extra capture operation on the cycle immediately before it is required to drive the bus. That is, the device will only expend energy when absolutely necessary. Thus, the method 400 could be modified for these devices to include the following steps before step 402: 1) determine if the device will drive output data during the next bus cycle; and 2) if it is determined that the device will drive output data during the next bus cycle, perform step 402 to capture the state of the bus, otherwise do not perform steps 402-440.

The method 400 is now illustrated by an example using a 4-bit data bus (comprising bits D3, D2, D1, D0) plus an inversion bit INV. In the example, the previous traffic D is 0101 (assuming an order of D3, D2, D1, D0), the previous inversion bit I is 0. The data to be output q is 0111. If the inversion bit INV is set to 0, then the output Q would be 0111, and INV would be 0, which would entail only a single data transition on D1. If the inversion bit INV is set to 1, then the output Q would be 1000, the inversion bit INV would be 1, which would entail four transitions (D3, D2, D0 and INV).

Therefore INV=0 is chosen because it minimizes the total number of transitions. Each single transition conceptually uses energy equaling approximately 0.5 CV², hence energy is minimized by minimizing the total number of transitions. Another way to consider energy is to account for it only when a transition from 0 to 1 occurs, because that is the cycle that actually draws current from the power supply and uses energy. Either way energy is accounted, when a statistically significant number of trials is simulated, the resulting energy savings is identical.

For the above 4-bit bus example, the inventor has determined that there is an energy savings despite the fact that an extra signal has been added to the transaction. This energy savings is statistically 22%. The inventor has also determined that an 8-bit bus (with a corresponding inversion bit) can save 19%, 16-bit bus (with a corresponding inversion bit) can save 14.6% and 32-bit bus (with a corresponding inversion bit) can save 11.3% of the bus energy. In comparison, prior art schemes that do not account for the transition of the inversion bit and have an algorithm that attempts to minimize only the 0 to 1 transitions will save only 11% on an 8-bit bus.

Another advantage of the illustrated method 400 is that the maximum number of bits that can transition at any time is only n/2 (i.e., half the number of bits on the bus). This reduces simultaneous switching noise in the system because a scheme that does not employ the method 400 can have n bits (i.e., all bit on the bus) switching for the same bus transactions. Therefore, it is possible to reduce the number of ground and power pins required in a device for I/O supply. This also provides a net reduction of the number of device pins despite the addition of the inversion bit pin.

FIG. 5 is a flowchart illustrating a bus inversion method 500 performed in accordance with an exemplary embodiment of the invention. In the illustrated method 500, it is presumed that the bus contains an odd number of bits n and an inversion bit INV. The output on the bus includes Q bits. The inversion bit INV is output on an inversion line associated with the bus. The method 500 is substantially the same as the method 400 (FIG. 4); however, since n is odd, the method 400 is simplified because the count C can never equal n/2 As such, steps 410 and 430 are removed from method 400 to create the new illustrated method 500.

The method 500 begins by capturing the previous (i.e., current) bus state (i.e., previously transmitted bits D and previously transmitted inversion bit I) at step 402. Next, the state of the bits to be transmitted q are determined and compared to the previously transmitted bits D (step 404). It should be appreciated that steps 402 and 404 could be reversed if so desired. A count C of the number of preview bits q that are the same as the previously transmitted bits D is obtained (step 406).

At step 408 it is determined if the count C is greater than n/2. That is, it is determined if the number of preview bits that match the previously transmitted bits is greater than half the number of bits on the bus. If the count is greater than n/2, then the inversion bit INV is set to zero (step 420), which indicates that the bits q should not be inverted (described below) and the method 500 continues at step 414.

If at step 408 it is determined that the count is not greater than n/2, the inversion bit INV is set to one (step 412), which indicates that the bits q should be inverted (described below). The method 500 continues at step 414, where it is determined whether the preview bits q should be inverted before being output onto the bus. If at step 414 it is determined that the inversion bit INV is set to zero, the method 500 outputs the preview bits q without inverting them as the bus output Q (step 440). If at step 414 it is determined that the inversion bit INV is not set to zero, the method 500 outputs inverted preview bits q as the bus output Q (step 416). Although not shown, the inversion bit INV is output on a corresponding inversion bit line.

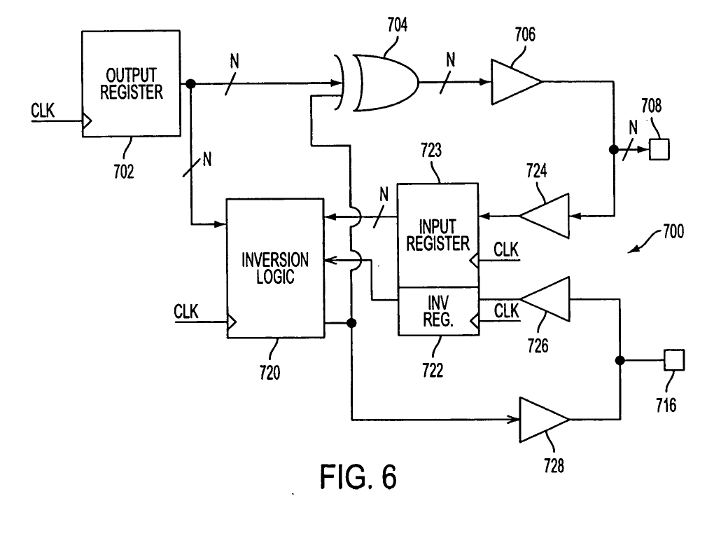

FIG. 6 is a diagram illustrating output driver circuitry 700 constructed in accordance with an embodiment of the invention. The illustrated circuitry 700 is activated in response, depending on perspective, to a write from a bus master to a slave or a read from the slave to the bus master. The illustrated circuitry 700 includes an output register 702, exclusive OR (XOR) circuit 704, two write drivers 706, 728, inversion logic 720, two input registers 722, 723 and two receivers 724, 726. The output register 702, clocked by a clock signal CLK, outputs n bits of information to be transmitted (i.e., preview bits) to the XOR circuit 704 and the inversion logic 720. The inversion logic 720, clocked by the clock signal CLK, inputs n bits of previously transmitted information from the first input register 723, and inputs the previously transmitted inversion bit from the second input register 722. The input registers 722, 723 are also clocked by the clock signal CLK. Although shown as separate registers, the input registers 722, 723 could be part of the same register or circuit if so desired.

The inversion logic circuit 720 determines if the preview bits require inversion or not based on one of the bus inversion methods of the invention. The inversion logic circuit 720 outputs a new inversion bit to the second write driver 728, which applies the inversion bit to an inversion bit line 716 and to the second receiver 726. The inversion logic circuit 720 outputs the inversion bit to the XOR circuit 704, which outputs inverted or non-inverted preview bits to the first write driver 706 based on the value of the inversion bit. The write driver 706 applies the bits to the bus lines 708 and to the first receiver 724. The output of the first receiver 724 is sent to the first input register 723. The output of the second receiver 726 is sent to the second input register 722. In addition, if bits are driven onto the bus lines 708 and inversion bit line 716 by another device, the bits and inversion bit are input into the circuit 700 via the receivers 724, 726 and input registers 723, 722. This is the captured state of the bus and inversion bit.

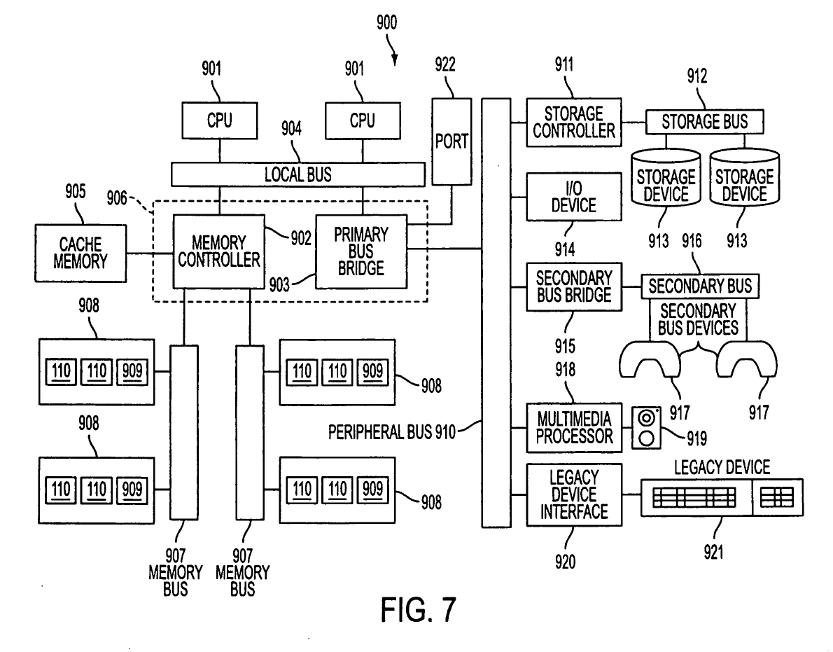

FIG. 7 is a block diagram of a processor system 900 utilizing bus inversion in accordance with any of the embodiments of the invention. That is, any of the components connected to the busses discussed below may utilize bus inversion as described above with respect to FIGS. 2-6, when it is deemed beneficial to do so. The processing system 900 includes one or more processors 901 coupled to a local bus 904. A memory controller 902 and a primary bus bridge 903 are also coupled to the local bus 904. The processing system 900 may include multiple memory controllers 902 and/or multiple primary bus bridges 903. The memory controller 902 and the primary bus bridge 903 may be integrated as a single device 906.

The memory controller 902 is also coupled to one or more memory buses 907. Each memory bus accepts memory components 908. The memory components 908 may be a memory card or a memory module. Examples of memory modules include single inline memory modules (SIMMs) and dual inline memory modules (DIMMs). The memory components 908 may include one or more additional devices 909. For example, in a SIMM or DIMM, the additional device 909 might be a configuration memory, such as a serial presence detect (SPD) memory. The memory controller 902 may also be coupled to a cache memory 905. The cache memory 905 may be the only cache memory in the processing system. Alternatively, other devices, for example, processors 901 may also include cache memories, which may form a cache hierarchy with cache memory 905. If the processing system 900 include peripherals or controllers which are bus masters or which support direct memory access (DMA), the memory controller 902 may implement a cache coherency protocol. If the memory controller 902 is coupled to a plurality of memory buses 907, each memory bus 907 may be operated in parallel, or different address ranges may be mapped to different memory buses 907.

The primary bus bridge 903 is coupled to at least one peripheral bus 910. Various devices, such as peripherals or additional bus bridges may be coupled to the peripheral bus 910. These devices may include a storage controller 911, a miscellaneous I/O device 914, a secondary bus bridge 915, a multimedia processor 918, and a legacy device interface 920. The primary bus bridge 903 may also coupled to one or more special purpose high speed ports 922. In a personal computer, for example, the special purpose port might be the Accelerated Graphics Port (AGP), used to couple a high performance video card to the processing system 900.

The storage controller 911 couples one or more storage devices 913, via a storage bus 912, to the peripheral bus 910. For example, the storage controller 911 may be a SCSI controller and storage devices 913 may be SCSI discs. The I/O device 914 may be any sort of peripheral. For example, the I/O device 914 may be a local area network interface, such as an Ethernet card. The secondary bus bridge may be used to interface additional devices via another bus to the processing system. For example, the secondary bus bridge may be a universal serial port (USB) controller used to couple USB devices 917 to the processing system 900. The multimedia processor 918 may be a sound card, a video capture card, or any other type of media interface, which may also be coupled to one additional devices such as speakers 919. The legacy device interface 920 is used to couple legacy devices, for example, older styled keyboards and mice, to the processing system 900.

The processing system 900 illustrated in FIG.7 is only an exemplary processing system with which the invention may be used. While FIG. 7 illustrates a processing architecture especially suitable for a general purpose computer, such as a personal computer or a workstation, it should be recognized that well known modifications can be made to configure the processing system 900 to become more suitable for use in a variety of applications. For example, many electronic devices which require processing may be implemented using a simpler architecture which relies on a CPU 901 coupled to memory components 908. These electronic devices may include, but are not limited to audio/video processors and recorders, gaming consoles, digital television sets, wired or wireless telephones, navigation devices (including system based on the global positioning system (GPS) and/or inertial navigation), and digital cameras and/or recorders. The modifications may include, for example, elimination of unnecessary components, addition of specialized devices or circuits, and/or integration of a plurality of devices.

It should be noted that there are several options of how to apply the bus inversion concept of the invention. It is natural to think of a bus in terms of groups of 8 bits (1 byte). Therefore, the invention could use one inversion bit per byte; if the bus is 16 bits there would be two inversion bits in total, four inversion bits for a 32-bit bus, etc. Some buses are based on groups of nine bits to allow parity or EDC (error detection and correction) bits. In those cases, the invention will utilize one inversion bit per group of nine bits. It is of course possible to use one inversion bit for a larger group of bits such as 16, 18, 32, 36, 64 or 72 bits if so desired. As set forth above, the energy savings is greater if smaller groups of signals are used rather than trying to use a single inversion bit for a whole wide bus.

The processes and devices described above illustrate exemplary methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the following claims should be considered part of the present invention.

What is claimed as new and desired to be protected by Letters Patent of the United States is:

1-63. (canceled)

64. An output driver for performing bus inversion on bits to be transmitted on a bidirectional bus from a first device to a second device, the driver comprising:
an output register configured to provide the bits and receive a clock signal;
a data circuit comprising:
a logic circuit coupled to an output of the output register;
a first write driver coupled to an output of the logic circuit;
at least one bus line coupled to an output of the first write driver;
a first receiver coupled to the output of the first write driver;
a first input register coupled to an output of the first receiver and configured to receive the clock signal;
an inversion bit circuit comprising:
a second input register configured to receive the clock signal;
a second receiver coupled to an input of the second input register;
an inversion bit line coupled to an input of the second receiver;
a second write driver coupled to the input of the second receiver; and
an inversion circuit comprising:
a first input configured to receive the clock signal;
a second input coupled to the output of the output register;
a third input coupled to the output of the data circuit;
a fourth input coupled to the output of the inversion bit circuit; and an output coupled to:
the data circuit, and
the inversion bit circuit.

65. The output driver of claim 64, wherein the logic circuit comprises an exclusive-or circuit.

66. The output driver of claim 64, wherein the at least one bus line comprises a bidirectional bus.

67. The output driver of claim 64, wherein the output of the data circuit comprises an output of the first input register.

68. The output driver of claim 64, wherein the output of the inversion bit circuit comprises an output of the second input register.

69. The output driver of claim 64, wherein the at least one bus line comprises an address bus line.

70. The output driver of claim 64, wherein the at least one bus line comprises a command bus line.

71. The output driver of claim 64, wherein the at least one bus line comprises a data bus line.
